(19) United States
(12) Patent Application Publication
(10) Pub. No.: US 2009/0012885 A1
(43) Pub. Date: Jan. 8, 2009

(54) Adjustable rate usage-based billing for data services

(76) Inventor: Robert S. Cahn, White Plains, NY (US)

Correspondence Address: AT&T CORP., ROOM 2A207, ONE AT&T WAY, BEDMINSTER, NJ, 07921, US

(21) Appl. No.: 10/750,548

(22) Filed: Dec. 31, 2003

(51) Int. Cl. G06Q 40/00; G06F 17/00

(52) U.S. Cl. 705/34; 705/400

(57) ABSTRACT

A method of providing adjustable rate usage-based billing for data services establishes an initial level billing rate based on customer estimates of usage and rates established by the provider based on the location of customer sites within predetermined geographic zones and levels of service intended to be used between those customer site pairs. The initial level billing rate is typically monthly, and is maintained during a predetermined level billing period. Upon expiration of the level billing period, the actual average usage on a monthly basis is calculated and compared to the level billing rate. If the absolute value of the percentage difference between them does not exceed a predetermined maximum adjustment, then the level billing rate for the next level billing period is set equal to the computed average of actual use during the just ended level billing period. If the maximum adjust is exceeded, the new level billing rate is capped at the maximum adjust percentage for the next level billing period. A carryover is provided by which whatever amount of increase or decrease is not covered by the maximum adjustment is carried over to the next level billing period, and is carried until it is finally recovered by either the customer or the provider, depending upon to which party the carryover has been accruing. This billing method is particularly useful in networks such as Multi-protocol Label Switching (MPLS), which provide the customer a certain amount of bandwidth for access to the network, but for which bandwidth is not pre-allocated to specific connections.

### BACKGROUND

Quite often, data transmission services are provided on a fixed-rate billing schedule. Typically, a contract is negotiated between a service provider and a customer for a fixed monthly payment based on the customer's estimated average usage (i.e. the average volume of data the customer expects to transmit over the service provider's data network and the geographic coverage required). The provider's network has associated fixed and operational costs that are directly related to the geographic proximity of the connections provided to the user. That is, the cost of providing a connection between two end-points generally increases with the geographic distance between them. The fixed rate offered by the provider typically contemplates an average of the costs between the sites (i.e. end-points) that the customer wishes to connect over the provider's network.

This traditional arrangement naturally flows from the nature of the network over which the data services are being provided. In a Frame Relay network, for example, terminating hardware at each of the end-point sites the customer wishes to connect via the network is connected to the network via local distribution channels (LDCs). The bandwidth available to each end-point is typically limited by the bandwidth of the LDC. Logical connections between the end-point sites are defined through software that resides in the provider's network and at the terminal equipment residing at the end-point sites. These circuits, known as permanent virtual circuits (PVCs), are the means by which data is transmitted between the data terminal equipment at various end-point sites of the customer. Based on the estimate of the customer's usage, a committed information rate (CIR) is established for each PVC. The CIR cannot exceed the physical bandwidth of the LDC, and is usually based on the estimate made by the customer. While the PVCs may be easily torn down or modified through software, they are intended to be long-term connections that remain open to transmission, much like a leased line.

Because Frame Relay and other similar network solutions are very connection oriented, it is difficult for a customer/user to seriously exceed the estimated bandwidth for those connections. Worst case, packets are dropped due to congestion or exceeding the physical bandwidth of the PVC and the loss to the provider is limited.

Fixed rate billing is a much more significant problem with a Multi-protocol Label Switching (MPLS) network. In this case, the provider typically only monitors data into and out of the cloud at the connection points. The user has allocated some total bandwidth of the cloud's capacity, and that capacity is not divvied up between connections as in the case of a Frame Relay network. A flat-rate billing arrangement for an MPLS network allows a customer to send their entire bandwidth of data traffic virtually anywhere on the network putting the provider in the position of being “cherry-picked.”

For example, it may be far more expensive from the provider's perspective to send a given amount of data traffic from the U.S. to the Ukraine than it is to send data from the U.S. to Canada, or between points within the U.S. This is because the provider must often negotiate for access to a network capacity local to the Ukraine, which could be quite expensive if there is little or no competition there. If the customer initially estimates that its data traffic will be reasonably spread out over the network between more and less expensive zones, a flat rate would likely contemplate this and would represent some weighted average of the cost to send data between all of the geographic zones. If the customer then only uses the provider's service to transport all of their bandwidth to the most expensive destinations, then the provider is under-compensated for the service.

This is quite analogous to the United States Postal Service, which charges a flat rate for first class mail from any point to any point in the country. The cost to the USPS of sending first class mail from Melbourne, Fla. to Austin, Tex. may be more expensive than the flat rate charged, but the USPS counts on all of those deliveries within town which cost less than the flat rate to deliver to make up for the expensive ones. If everyone used the USPS to send letters to far off locations, and used some other service to make local deliveries that was cheaper than the USPS first class flat rate, then the USPS would be under-compensated as well.

Of course, providers would prefer to provide their data service based on actual usage between sites in the same and different zones and classes of service, with the rate varying between the various connections between zones depending on the COS and the cost of providing each of the connections (in a manner similar to traditional long-distance telephone usage). Usage can be easily monitored by the provider at various points in the network, including Customer Edge (CE) routers and Provider Edge (PE) routers. Customers, however, are reluctant to migrate to usage based billing, and for very legitimate reasons. First, enterprise clients like to be able to plan for and budget costs such as network access to data services. If usage is significantly greater than anticipated, the budget can be immediately and severely impacted. Also, it may be difficult for a large entity to gain control of usage by particular sites, groups or even individuals quickly enough to control the over-budget expenses before they have become a problem.

Thus, it would be beneficial if a process of billing for data services could be provided that helped protect providers from being under-compensated while protecting their customers from exposure to large and unexpected increases in usage that are difficult to assess and bring under control quickly.

### SUMMARY

This disclosure describes processing methods and system structures that address one or more of the issues noted above. In at least one embodiment, a method of providing adjustable rate usage-based billing for data services includes billing for data services at a current level billing rate over a current level billing period. An average actual usage rate is determined over the current level billing period upon its expiration. If the absolute value of the percentage difference between the current level billing rate and the average actual usage rate is less than a maximum adjustment, a new level billing rate for a next level billing period is set equal to the average actual usage rate. Otherwise the new level billing rate is set equal to the current billing rate plus a percentage of the current billing rate equal to the maximum adjustment if the difference between the current level billing rate and the average actual usage rate is greater than 1. Otherwise, the new level billing rate is set equal to the current billing rate less a percentage of the current billing rate equal to the maximum adjustment if the difference between the current level billing rate and the average actual usage rate is less than 1. The current level billing rate is then defined as the new level billing rate and the next level billing period is defined as the current level billing period. The process is repeated for each current level billing period upon its expiration.

In an embodiment, a carryover is established for any difference between the average actual usage cost per billing cycle and the new level billing cost per billing cycle established for the next level billing period. The carryover is retained until recovered.

### BRIEF DESCRIPTION OF THE DRAWINGS

For a detailed description of embodiments of the invention, reference will now be made to the accompanying drawings in which:

FIG. 1 is a diagram of an example rate array that may be used in accordance with an embodiment of the invention;

FIG. 2 is a block diagram representation of the functional operation of an embodiment of the invention;

FIG. 3 is a table diagram illustrating the results of an example of the operation of an embodiment of the invention.

### NOTATION AND NOMENCLATURE

Certain terms are used throughout the following description and in the claims to refer to particular methods and structures used in performing them. As one skilled in the art will appreciate, those skilled in the art may refer to functions and structures by different names. This document does not intend to distinguish between components, structures, materials or methods that differ in name but not function. In the following discussion and in the claims, the terms “including” and “comprising” are used in an open-ended fashion, and thus should be interpreted to mean “including, but not limited to . . . . ”

### DETAILED DESCRIPTION

The following discussion is directed to various embodiments of the invention. Although one or more of these embodiments may be preferred, the embodiments disclosed should not be interpreted as or otherwise used to limit the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

In an embodiment of the invention, a method for adjustable rate billing of data services provides for a compromise between flat fee billing, which tends to under-compensate the provider, and usage based billing, which can lead to steep fluctuations in the rate at which the consumer is billed. Those of skill in the art will recognize that the embodiments of the adjustable rate billing method of the invention may be implemented on any computer system, from notebooks to desk top PCs to large servers capable of handling huge amounts of data. Embodiments of the method of the invention would typically reside in a computer system's memory, and called for execution by a user manually or automatically as is well-known in the art.

A rate array for each customer may be used to define the various geographical zones in which the customer has sites (i.e. endpoints) that the customer wishes to interconnect over the provider's network. Those of skill in the art will recognize that the network can be any network implementation that provides data services between sites of a customer, and which can be adapted to record the usage (e.g. Megabytes) transmitted by the user between the sites connected to the network. One example is a frame relay network. The customer provides or is provided with data terminal equipment (DTE) at each customer site. The DTE at each site is coupled to the network provider's point of presence (POP) in the geographic vicinity of the customer's site through a connection sometimes known as a local distribution channel (LDC).

The network is set up to monitor the customer's usage between sites in the various zones of the network. Those of skill in the art will recognize that known techniques exist by which this may be accomplished. For example, the network may monitor data transmitted and received over the LDC at the port established for the customer at the provider's POP. Routers have also been used as points at which data usage may be monitored and logged as previously mentioned. The techniques used for monitoring usage and as well as network protocols and components are generally applicable to embodiments of the invention and the details are therefore beyond the scope of this disclosure.

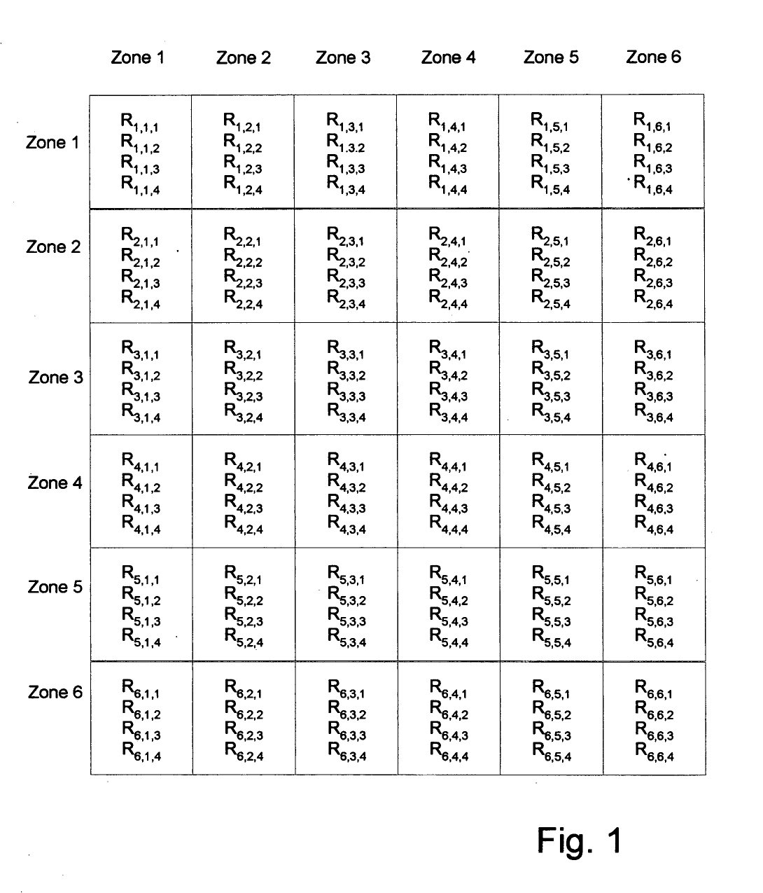

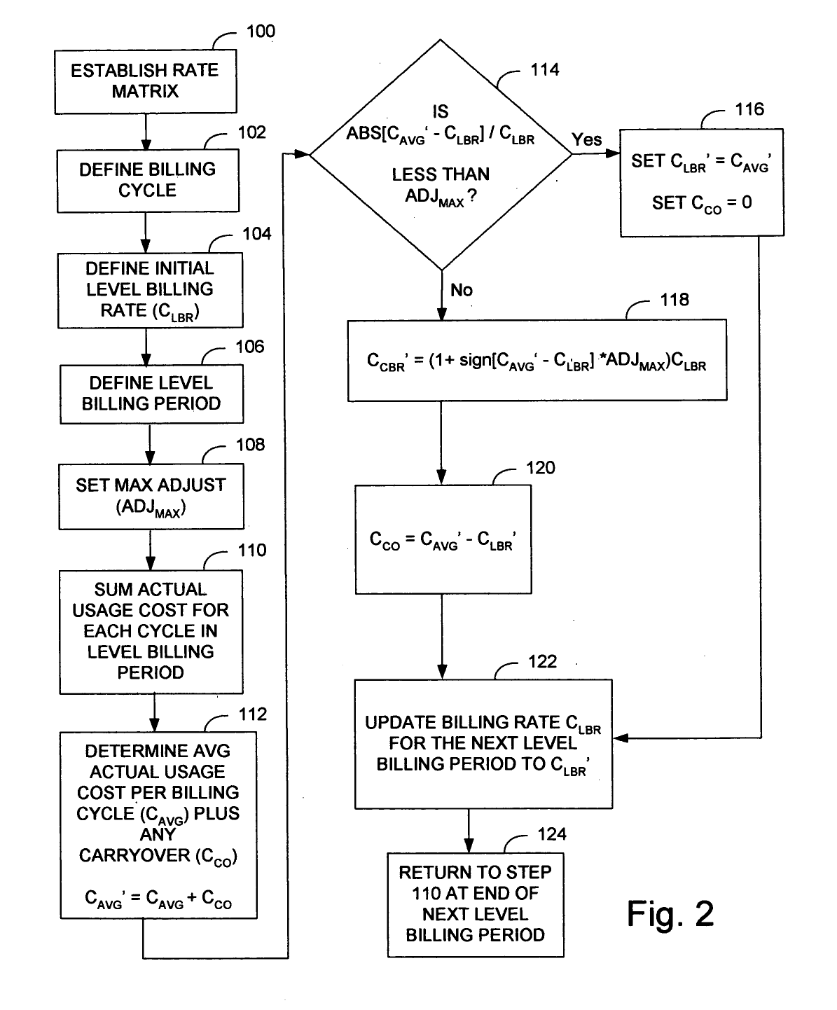

In an embodiment of the invention, a rate array such as the one illustrated in FIG. 1 may be established by the provider to define the rates (e.g. cost per Megabyte) between each of the zones in which a customer's endpoint sites reside and further differentiated by the class of service (CoS). This function is illustrated as block 100 in FIG. 2. The rates typically would be based on any criteria that rationally establish the rates as a function of the costs incurred by the provider in supplying the service to the customer, including geographic distance between the zones, maintenance costs, access costs if the provider must access a network not owned by the provider to provide the connection between sites in two zones, etc. Moreover, multiple rates may be established between the same site pair based on different classes of service (COS) offered between the same site pair. Those of skill in the art will recognize that more than four classes may be offered, and that rates for traffic from a first Zone to a second Zone will likely be equal to rates for traffic from the second zone to the first which might simplify the array. The array of FIG. 1 is intended to illustrate a more general array for purposes of example only.

Thus, as illustrated, flows between sites within Zone 1 may have for example 4 rates for 4 different classes of service (R_{1,1,1}-R_{1,1,4}). Likewise, flows between sites in Zones 2 and 6 are charged at rates (R_{2,6,1}-R_{2,6,4}) and (R_{6,2,1}-R_{6,2,4}). Those of skill in the art will recognize that the rates for transmission between sites in different Zones are likely to be symmetrical in both directions, but in the general they do not have to be. Based on the rates quoted to the customer, the customer then estimates the usage expected between each of the sites on some periodic basis, such as on a monthly basis. This is illustrated as block 102 in the flow diagram of FIG. 2. Estimates of usage in the form of flow rates F_{i,j,c} for each site pair (and each class of service between the site pair) are multiplied by the appropriate rate R_{i,j,c} for each site pair, and the estimated costs are summed to establish an initial level billing rate C_{LBR}. The sum of the estimated costs may be determined by the following equation:

$${C}_{L B R} = {\sum }_{i , j , c} {R}_{i , j , c} * {F}_{i , j , c} . \qquad ( 1 )$$

This summation is illustrated as block 104 of the flow diagram of FIG. 2.

A level billing period is then established over which the C_{LBR} is to remain unchanged, and upon expiration of which C_{LBR} may be adjusted in response to any increase or decrease in actual usage and the cost therefore compared to the C_{LBR} in effect over the just expired level billing period. For example, the provider and customer may agree that the level billing period might be 6 months, or a year. Establishing this parameter (typically through negotiation and likely reflected in a service contract) is block 106 of FIG. 2. Another parameter that must be established between the provider and the customer is the maximum amount ADJ_{MAX} by which the C_{LBR} may be increased or decreased upon expiration of each level billing period. The parameter ADJ_{MAX} would typically be given as a percentage. For example, it may be agreed that the maximum that C_{LBR} should be permitted to change between level billing periods is ten percent. This corresponds to block 108 of FIG. 2.

Upon expiration of the current level billing period, the cost for actual usage per billing cycle of the just expired level billing period is determined. In the example, the billing cycle is one month and the level billing period is six months, so the number of billing cycles in the level billing period, n, is six. Thus, the cost for each cycle n is determined using the following equation:

$${C}_{n} = {\sum }_{i , j , c , n} {R}_{i , j , c , n} * {F}_{i , j , c , n} . \qquad ( 2 )$$

This is the same as equation (1) above, except the values for F_{i,j,c,n} are the actual data flow or usage recorded by the provider over the network, rather than the initial estimates. This is performed at block 110 of FIG. 2.

An average cost for the n cycles C_{AVG} is then determined by the following equation:

$${C}_{AVG} = \frac{{C}_{1} , … , {C}_{n}}{n} . \qquad ( 3 )$$

In an embodiment of the invention, an additional parameter is employed called the carryover (C_{CO}), which is essentially actual costs incurred over and above the C_{LBR} of one or more previous level billing periods that have yet to be recovered based on previous allowable increases in the C_{LBR} for the current or previous level billing periods. If the carryover is not employed, those costs that exceeded the actual rate paid (i.e. the C_{LBR}) may not all be recovered by the provider. Those of skill in the art will recognize that at the end of the first level billing period, there will be no carryover amount (i.e. C_{LBR}=0). Those of skill in the art will recognize that an embodiment that does not employ the carryover may be implemented if desired. For an embodiment employing the carryover, a new parameter C_{AVG}′ is determined by:

C_{AVG}′=C_{AVG}+C_{CO} (4).

This is performed at block 112 of FIG. 2.

If the absolute value of the percentage difference between the actual average cost (plus carryover if any) C_{AVG}′ incurred over the just ended level billing period and the level billing rate form the just-ended level billing rate C_{LBR} is less than ADJ_{MAX}, then the new adjusted level billing rate C_{LBR}′ will simply be set equal to the C_{AVG}′ for the previous level billing period. C_{CO} will be set to zero because any of the deficit in what was paid versus what was actually over the just ended level billing period will be accommodated by the increase in the new level billing rate C_{LBR}′ over the next level billing period. This is performed at decision block 114 and because the answer is in the affirmative, processing continues at block 116 of FIG. 2.

Those of skill in the art will recognize that this works for both provider and customer, as any overage that does not exceed the maximum permitted adjustment ADJ_{MAX} will be recovered over the next level billing period. This includes any underage carried over from previous level billing periods not recovered by the provider in the just-ended level billing period. Likewise, if the amount paid over the previous level billing period per billing cycle was greater than the average cost of actual use over the level billing period just ended, then the amount paid per billing cycle decreases by that difference in the next level billing period. That also includes any overage from previous level billing periods not recovered by the customer over the just-ended level billing period.

If the determination at decision block 114 of FIG. 2 is in the negative, then processing continues at block 118, where the new level billing rate for the upcoming level billing period C_{LBR}′ is limited to the ADJ_{MAX} and takes on the sign (i.e. positive or negative) depending on the sign of the difference between C_{AVG}′ and C_{LBR}. The new level for the upcoming level billing period is therefore determined by the following equation:

C_{LBR}′=(1+sign(C_{AVG}′−C_{LBR})*ADJ_{MAX})C_{LBR}. (5)

Thus, the new level billing rate C_{LBR}′ will equally the level billing rate for the just-ended level billing period C_{LBR} plus or minus ADJ_{MAX} of the just-ended level billing period C_{LBR}. In addition, because the increase or decrease in the level billing rate is being capped at ADJ_{MAX}, a carryover amount C_{CO} is generated that is determined by: C_{CO}=C_{AVG}′−C_{LBR}′. This is determined at block 120 of FIG. 2. Once completed, the processing returns at 122 to 110, where the process is repeated as previously described at the end of the next level billing period. Of course, those of skill in the art will recognize that changes in the initial conditions, such as increases in the rates for one or more zones, the addition or deletion of PVCs from the customer's sites, an increase or decrease in the ADJ_{MAX} parameter or the length of the level billing period may require processing to return to other blocks in the flow to accommodate those changes.

In an embodiment of the invention, the value of ADJ_{MAX} may be automatically increased or decreased if the difference between the actual average cost per cycle over the just-ended level billing period has exceeded or fallen short of the level billing rate for that period by some amount. Those of skill in the art will recognize that this permits the convergence between the costs billed versus the cost of actual use to be accelerated in the event that the two become too far apart for some reason. Moreover, the length of the level billing periods could be automatically adjusted in the same manner, as the shorter the level billing periods, the faster is the convergence as well.

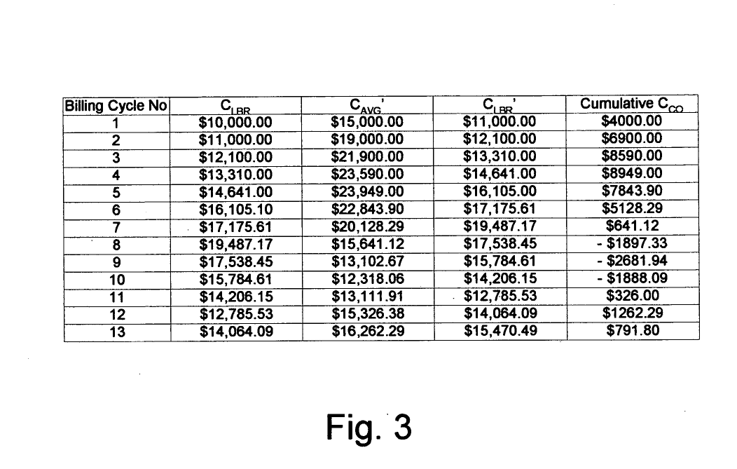

FIG. 3 is a table that illustrates an example of the use of an embodiment of the invention. In the example of FIG. 3, the customer estimates usage of $10,000 per month, but actually uses services of $15,000 per month in accordance with a rate table established for the various sites which the customer wants to connect. In the example, the cycle is monthly, the level billing period is six months, and the ADJ_{MAX} parameter is 10%. The table also shows the cumulative carryover so that it can be seen how it is being reduced over time. From the example it can be seen that the level billing rate C_{LBR} eventually converges to the actual cost per cycle of $15,000. Those of skill in the art will also recognize that increasing the ADJ_{MAX} parameter and/or decreasing the level billing period will shorten the time necessary for the level billing rate to converge to the actual cost of services used per billing cycle. Also, it will be seen that the provider can add a provision it a contract with a customer that any cumulative carryover at the time a service contract is terminated will be due immediately to the provider if positive, or due immediately to the customer if negative.

In summary, embodiments of the invention employ an adjustable rate usage based billing technique for data services that provides a compromise between flat rate billing as desired by the consumer, and usage based billing desired by the provider. Embodiments of the invention give the provider the means by which to eventually recover costs of actual usage versus the initial or most recent billing rate, while providing the consumer with some insulation from large fluctuations in data services usage. For some period of time, the consumer can be certain that the billing rate is known and stable, and at the end of that period, there is a maximum by which that stable billing rate can be increased. The provider can be assured of collecting just compensation for the actual services used by its customers and eliminates the negative effects of excessive under-estimation of initial bandwidth usage and cherry-picking by some of its customers.

What is claimed is:

1. A method of providing adjustable rate usage-based billing for data services, said method comprising:
billing for data services at a current level billing rate over a current level billing period;
determining an average actual usage rate over the current level billing period upon its expiration;
if the absolute value of the percentage difference between the current level billing rate and the average actual usage rate is less than a maximum adjustment, then setting a new level billing rate for a next level billing period equal to the average actual usage rate, otherwise setting the new level billing rate equal to the current billing rate plus a percentage of the current billing rate equal to the maximum adjustment if the difference between the current level billing rate and the average actual usage rate is greater than 1, and set the new level billing rate equal to the current billing rate less a percentage of the current billing rate equal to the maximum adjustment if the difference between the current level billing rate and the average actual usage rate is less than 1;
establishing the current level billing rate as the new level billing rate and the next level billing period as the current level billing period; and
repeating said determining an average actual usage rate, said setting a new level billing rate and said establishing for each current level billing period upon its expiration.

2. The method of claim 1 further comprising computing a carryover cost for the next level billing period equal to the difference between the actual average rate of the current level billing period and the new level billing rate for the next level billing period.

3. The method of claim 2 wherein said determining an average actual usage rate further comprises:
computing an actual cost per each billing cycle of the expired current level billing period and averaging the actual cost for each billing cycle over the total number of billing cycles in the expired current level billing period; and
adding the average actual cost per billing cycle to the carryover cost per billing cycle for the current level billing period.

4. The method of claim 4 wherein the maximum adjustment is increased if the absolute value of the difference between the current level billing rate and the actual usage rate is greater than some predetermined value.

5. The method of claim 1 wherein the maximum adjustment is increased if the absolute value of the difference between the current level billing rate and the actual usage rate is greater than some predetermined value.

6. The method of claim 1 wherein an initial current level billing rate is based on a customer's estimates of network usage and usage rates established by a provider of the data services.

7. The method of claim 6 wherein the usage rates vary based on zones in which customer data sites are located.

8. The method of claim 7 wherein the usage rates vary further based on what class of service is used between pairs of customer data sites.

9. The method of claim 1 wherein the number of billing cycles comprising a level billing period are decreased if the absolute value of the difference between the current level billing rate and the actual usage rate is greater than some predetermined value.

10. The method of claim 1 wherein the average actual usage rate is determined based on actual data services usage and usage rates established by a provider of the data services.

11. The method of claim 10 wherein the usage rates vary based on zones in which customer data sites are located.

12. The method of claim 11 wherein the usage rates vary further based on what class of service is used between pairs of customer data sites.
